(19) United States
(12) Patent Application Publication
(10) Pub. No.: US 2026/0108401 A1
(43) Pub. Date: Apr. 23, 2026

(54) ELECTRIC WHEELCHAIR AND POWER UNIT OF ELECTRIC WHEELCHAIR

(71) Applicant: Yamaha Hatsudoki Kabushiki Kaisha, Shizuoka (JP)

(72) Inventor: Shintaro OHNISHI, Shizuoka (JP)

(21) Appl. No.: 19/360,969

(22) Filed: Oct. 16, 2025

(30) Foreign Application Priority Data
Oct. 23, 2024 (JP) 2024-186964

(51) Int. Cl. A61G 5/04; A61G 5/10

(52) U.S. Cl. CPC A61G 5/045; A61G 5/10

(57) ABSTRACT

An electric wheelchair includes an electric motor mounted on a right wheel, an electric motor mounted on a left wheel, a battery that supplies a current to the electric motors, and a battery holder that is disposed closer to the right wheel than a center of the electric wheelchair in a left-right direction and houses the battery. The battery holder opens toward an inward direction, which is a direction facing the center of the electric wheelchair in the left-right direction, and toward a top of the electric wheelchair.

### CROSS-REFERENCE TO RELATED APPLICATION

The present application claims priority from Japanese application No. 2024-186964 filed on October 23, 2024, the content of which is hereby incorporated by reference into this application.

### BACKGROUND OF THE INVENTION

### 1. Field of the Invention

The present disclosure relates to an electric wheelchair and a power unit of the electric wheelchair.

### 2. Description of the Related Art

JP2015-198814A discloses an electric wheelchair. The electric wheelchair includes the electric motors disposed on the left and right wheels and the battery for supplying power to the electric motors. The electric wheelchair disclosed in JP2015-198814A is foldable so that the distance between the left and right wheels is reduced. The battery pack for storing the battery is disposed on the back of the backrest of this electric wheelchair.

Unlike the electric wheelchair in JP2015-198814A, the electric wheelchair having the battery holder disposed along the wheel is also used. In this type of electric wheelchair, the battery holder is box-shaped with an opening at the top and includes four walls surrounding the left, front, right, and rear surfaces of the battery.

Electric wheelchairs may be loaded into a car in a folded state or stored at home in a folded state. As such, when folded, it is desirable that the electric wheelchair has a narrow width in the left-right direction.

### SUMMARY OF THE INVENTION

(1) A power unit proposed in the present disclosure of an electric wheelchair that includes a first wheel, which is one of a right wheel or a left wheel, and a second wheel, which is the other one of the right wheel or the left wheel, and is foldable so as to reduce a distance between the first wheel and the second wheel. The power unit includes a first electric motor mounted on the first wheel, a second electric motor mounted on the second wheel, a battery that supplies a current to the first electric motor and the second electric motor, and a battery holder that is disposed closer to the first wheel than a center of the electric wheelchair in a left-right direction and houses the battery. The battery holder opens toward an inward direction, which is a direction facing the center of the electric wheelchair in the left-right direction, and toward a top of the electric wheelchair.

(2) In the power unit of (1), the battery includes a first side surface facing in the inward direction. When the battery is mounted on the battery holder, the entire first side surface is exposed from the battery holder in the inward direction.

(3) In the power unit of (1) or (2), the battery includes a front surface facing forward of the electric wheelchair and a rear surface facing rearward of the electric wheelchair. The battery holder includes a front wall part along the front surface and a rear wall part along the rear surface. The front wall part includes a first inner surface along the front surface of the battery. The rear wall part includes a second inner surface along the rear surface of the battery. A width of the first inner surface and the second inner surface in the left-right direction is smaller than a width of the battery in the left-right direction.

(4) In the power unit of (3), when the battery and the battery holder are viewed in a front-rear direction, a center of gravity of the battery overlaps with the front wall part and the rear wall part.

(5) In the power unit of (3) or (4), when the battery and the battery holder are viewed in the front-rear direction, a plane passing through the center of the battery in the left-right direction intersects the front wall part and the rear wall part.

(6) In the power unit of any one of (3) to (5), an upper surface of the front wall part and an upper surface of the rear wall part are positioned higher than the center of the battery in a vertical direction.

(7) In the power unit of any one of (1) to (6), the battery includes a first side surface facing in the inward direction and a second side surface facing in an outward direction, which is opposite to the inward direction. The battery holder includes a side wall part along the second side surface of the battery. The side wall part includes an inner surface facing in the inward direction. A top of the inner surface includes a slope. The slope extends diagonally from a lower edge of the slope upward and in the outward direction.

(8) In the power unit of any one of (1) to (7), the battery holder includes a guide part. The battery includes a guided part. The guide part and the guided part allow a movement of the battery in a vertical direction with respect to the battery holder and restricts a movement of the battery in the inward direction from the battery holder.

(9) An electric wheelchair proposed in the present disclosure includes the power unit, the first wheel, and the second wheel of any one of (1) to (8).

(10) The electric wheelchair of (9) includes a stopper part that is positioned closer to the second wheel than the center of the electric wheelchair in the left-right direction. The battery holder includes a stopped part. When the electric wheelchair is folded, the stopper part and the stopped part come into contact with each other so as to prevent a distance between the first wheel and the second wheel from being smaller than a predetermined value.

(11) In the electric wheelchair of (10), the battery holder includes a side surface facing in the inward direction. The stopped part is provided on the side surface.

(12) In the electric wheelchair of (10) or (11), the battery holder includes a bottom part that supports a lower surface of the battery. The stopped part is provided on the bottom part.

(13) In the electric wheelchair of any one of (10) to (12), the battery includes a front surface facing forward of the electric wheelchair and a rear surface facing rearward of the electric wheelchair. The battery holder includes a front wall part along the front surface and a rear wall part along the rear surface. The battery includes a part that is positioned further in the inward direction from a side surface of the front wall part and a side surface of the rear wall part when the battery is mounted on the battery holder, the side surfaces facing in the inward direction. A space to dispose the part of the battery is provided in the inward direction of the battery holder. In a state where the battery is removed from the battery holder and the electric wheelchair is folded, a frame of the electric wheelchair which is closer to the second wheel is positioned in front of the space.

(14) In the electric wheelchair of any one of (9) to (13), the battery includes a first side surface facing in the inward direction and a second side surface facing in an outward direction, which is opposite to the inward direction. The battery holder includes a side wall part along the second side surface of the battery. The side wall part includes an inner surface facing toward a center of the electric wheelchair in a left-right direction. A top of the inner surface includes a slope extending diagonally from a lower edge of the slope upward and in the outward direction. The battery holder is supported away from the first wheel in the inward direction.

### BRIEF DESCRIPTION OF THE DRAWINGS

FIG. 1 is a rear-left perspective view of an electric wheelchair;

FIG. 2 is a rear-right perspective view of the electric wheelchair;

FIG. 3 is a rear view of a battery holder, a battery, and a right wheel;

FIG. 4 is a perspective view of the battery holder;

FIG. 5 is a plan view of the battery holder;

FIG. 6A is a left side view of the battery;

FIG. 6B is a perspective view of the battery; and

FIG. 7 is a back view of a folded frame.

### DETAILED DESCRIPTION OF THE INVENTION

The present disclosure is to be considered as an exemplification of the invention, and is not intended to limit the invention to the specific embodiments illustrated by the figures or description below. The present invention will now be described by referencing the appended figures representing embodiments.

The terminology used herein is for the purpose of describing particular embodiments only and is not intended to be limiting of the invention. As used herein, the term "and/or" includes any and all combinations of one or more of the associated listed items. As used herein, the singular forms "a," "an," and "the" are intended to include the plural forms as well as the singular forms, unless the context clearly indicates otherwise. It will be further understood that the terms "comprises", "comprising", "includes", and/or "including", when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of technologies are disclosed. Each of these has individual benefit and each can also be used in conjunction with one or more, or in some cases all, of the other disclosed technologies. Accordingly, for the sake of clarity, this description will refrain from repeating every possible combination of the individual technologies in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

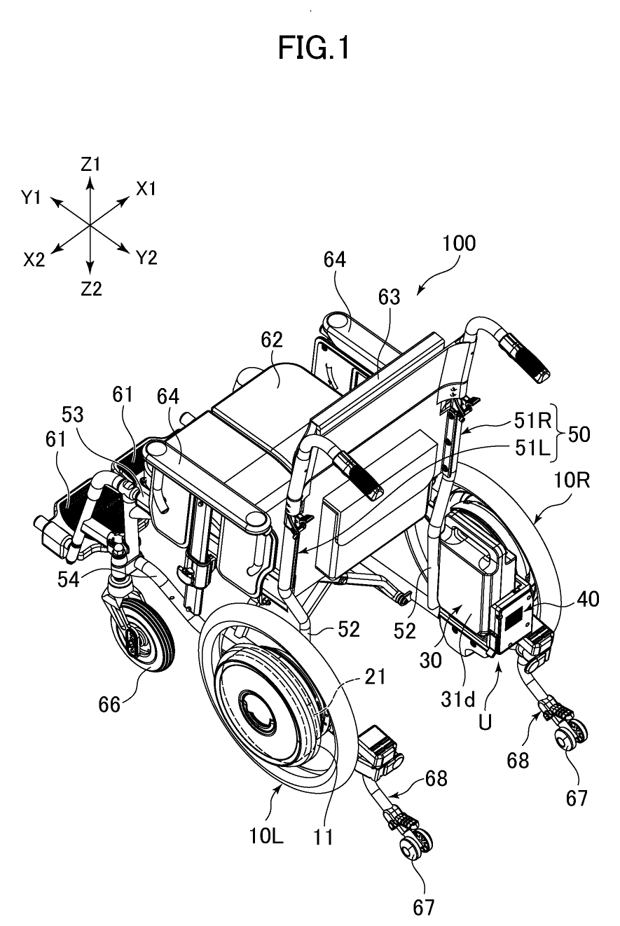

An electric wheelchair and a power unit of the electric wheelchair proposed in the present disclosure will be described. In the following, an electric wheelchair 100 and a power unit U shown in FIG. 1 are explained as examples of the electric wheelchair and the power unit proposed in the present disclosure. The power unit U includes left and right electric motors 21, a battery 30, and a battery holder 40 as components to be described later.

In the following, a Z1 direction and a Z2 direction shown in FIG. 1 will be referred to as an upward direction and a downward direction, respectively. Further, a Y1 direction and a Y2 direction shown in FIG. 1 are referred to as a forward direction and a backward direction, respectively, and an X1 direction and an X2 direction also shown in FIG. 1 are referred to as a right direction and a left direction, respectively.

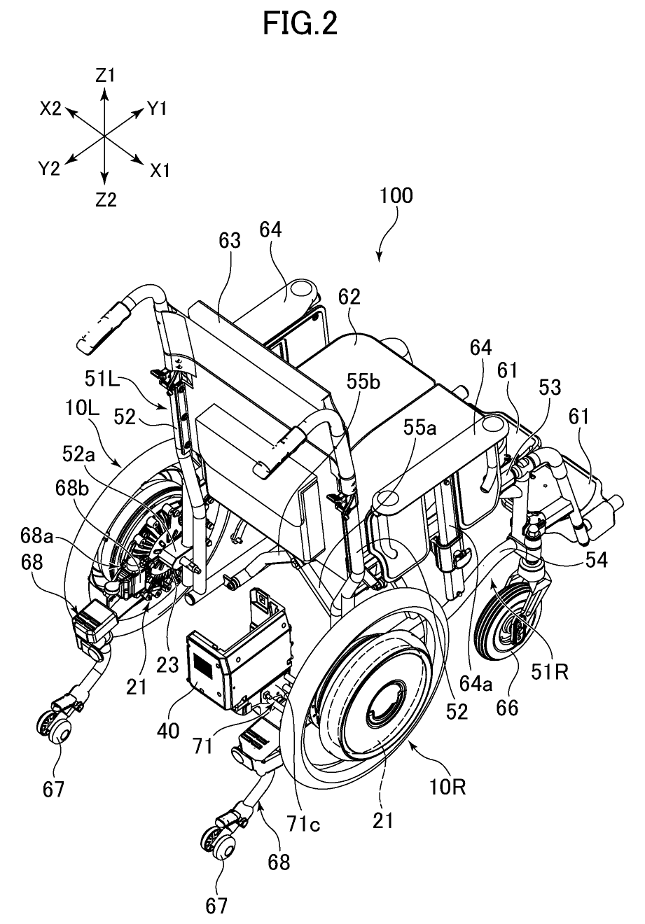

As shown in FIG. 1, the electric wheelchair 100 includes wheels 10R and 10L disposed on the right and left parts of the vehicle body, respectively. Each of the wheels 10R and 10L includes a hub 11 and an electric motor 21 disposed inside the hub 11. The electric motor 21 includes a motor housing 23 (see FIG. 2), a rotor housed in the motor housing 23, and a stator. Rotation of the rotor is transmitted to the hub 11 via a reduction mechanism disposed inside the hub 11.

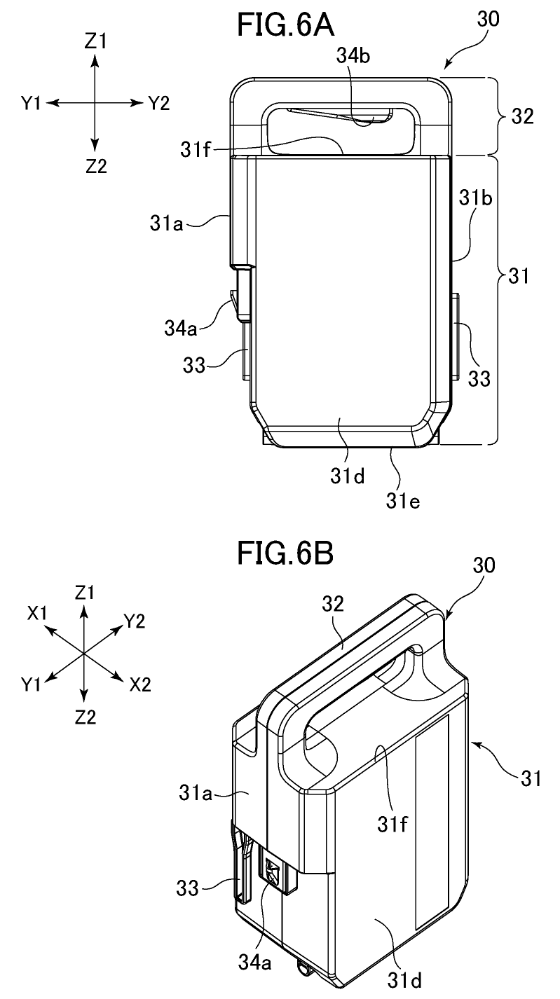

As shown in FIG. 1, the electric wheelchair 100 includes the battery 30 for storing power supplied to the electric motor 21, and the battery holder 40 for holding the battery 30. The battery 30 is electrically connected to the electric motors 21 mounted on the left and right wheels 10L and 10R via cables. As shown in FIG. 6A, the battery 30 includes a battery body 31 containing a plurality of battery cells and a handle 32 provided on the top of the battery body 31.

As shown in FIG. 1, the electric wheelchair 100 includes casters 66 positioned in front of wheels 10R and 10L, a foot support 61 for a user to put their feet, a seat 62 on which the user sits, a back support 63 for supporting the user's back, and arm supports 64 for the user to put their arms. An operation unit (not shown) that receives an operation of the user is disposed in front of the arm support 64. The user can input instructions on the direction and speed of the wheelchair 100 to the control device by such an operation unit.

As shown in FIG. 1, the electric wheelchair 100 has a frame 50. The frame 50 includes a right frame portion 51R constituting the right part of the vehicle body and a left frame portion 51L constituting the left part of the vehicle body. Each of the right frame portion 51R and the left frame portion 51L includes a rear frame portion 52, a seat frame portion 53, and a lower frame portion 54, for example. The rear frame portion 52 extends vertically and supports the right and left parts of the back support 63. The seat frame portion 53 extends forward from the rear frame portion 52 and supports the right and left parts of the seat 62 and the left and right arm supports 64. The lower frame portion 54 extends forward from the rear frame portion 52 and supports casters 66, for example.

The left wheel 10L and the right wheel 10R are supported by the left frame portion 51L and the right frame portion 51R, respectively. As shown in FIG. 2, support portions 52a protruding backward are formed at the lower parts of the rear frame portions 52, for example. The axles of the wheels 10L and 10R are supported by the support portions 52a. For example, the axles are inserted into through holes formed in the support portions 52a.

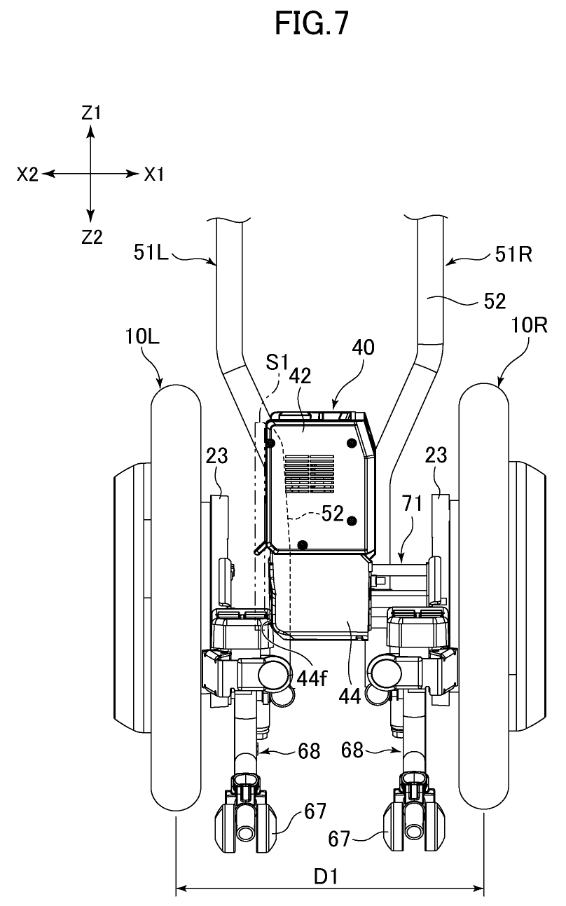

The frame 50 can be folded so that the distance between the left and right wheels 10L and 10R is shortened (see FIG. 7).

For example, as shown in FIG. 2, the frame 50 includes movable arms 55a and 55b for coupling the left and right frame portions 51L and 51R. The two movable arms 55a and 55b are disposed so as to intersect and are coupled to each other via a coupling shaft at the intersecting position. The upper ends of the two movable arms 55a and 55b are respectively coupled to the right frame portion 51R and the left frame portion 51L via the coupling shaft. The lower ends of the two movable arms 55a and 55b are respectively coupled to the left frame portion 51L and the right frame portion 51R via the coupling shaft. The movable arms 55a and 55b are moved so as to reduce the angle between the movable arms 55a and 55b, and the distance between the left and right frame portions 51L and 51R is thereby reduced to allow the frame 50 to be folded.

### Battery holder

As shown in FIG. 1, the battery holder 40 is disposed closer to the right wheel 10R than the center of the electric wheelchair 100 in the left-right direction. The battery holder 40 is disposed inside the right wheel 10R (center side in the left-right direction) and along the right wheel 10R.

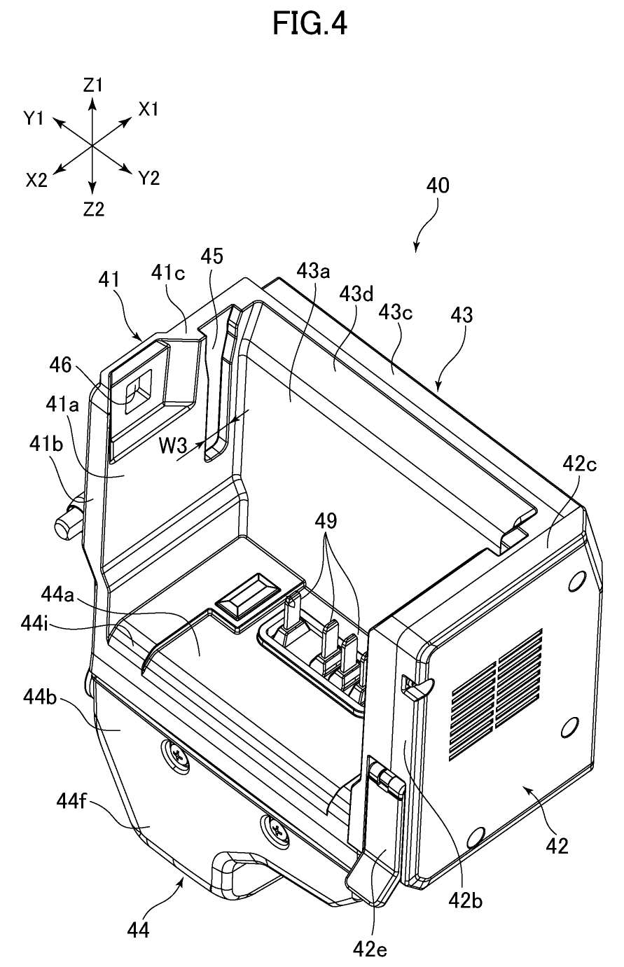

As shown in FIG. 4, the battery holder 40 includes a front wall part 41 disposed along a front surface 31a of the battery 30, a rear wall part 42 disposed along a back surface 31b of the battery 30, and a right wall part 43 disposed along a right side surface 31c of the battery 30. The battery holder 40 also includes a bottom part 44 supporting the bottom surface of the battery 30.

As shown in FIG. 4, the battery holder 40 includes a plurality of terminals 49 for electrically connecting to the battery 30. The terminals 49 are provided on the upper surface of the bottom part 44, for example. The terminals 49 protrude upward from the upper surface 44a of the bottom part 44. The bottom part 44 may contain a terminal base to which the terminals 49 are attached and a cable connected to the terminal base. The lower surface of the battery 30 includes terminal holes through which the terminals 49 are inserted.

Unlike the example shown in FIG. 4, the terminals 49 may be provided on another wall of the battery holder 40. For example, the terminals 49 may be provided on the right wall part 43 of the battery holder 40. In this case, the right side surface 31c of the battery 30 may include terminals for connecting to the terminals 49.

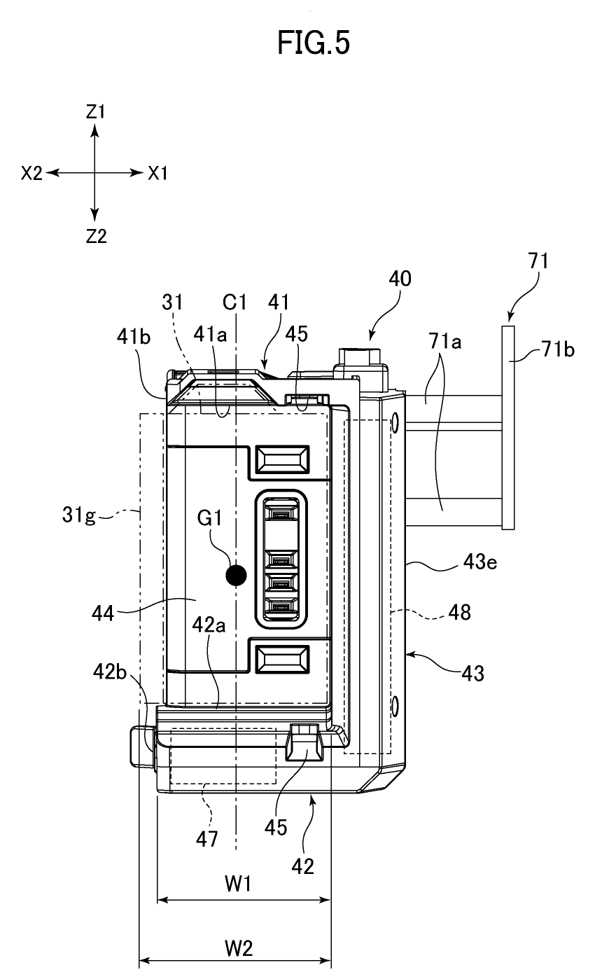

Parts relating to charging/discharging the battery 30 may be disposed on the wall part of the battery holder 40. For example, as shown in FIG. 5, a circuit board 48 may be stored in the right wall part 43 of the battery holder 40. For example, an electric circuit for supplying power of the battery 30 to the left and right electric motors 21 is mounted on the circuit board 48. An electric circuit for supplying power of the battery 30 to the control device for controlling the electric motors 21 may be mounted on the circuit board 48.

The battery holder 40 may be configured such that the battery 30 can be charged by power supplied from an external power supply device while the battery 30 is mounted on the battery holder 40. In this case, the battery holder 40 may have a connector for connecting a cable extending from the external power supply device. The connector may be provided on the rear wall part 42 of the battery holder 40, for example.

As shown in FIG. 4, an openable connector cover 42e covering the connector may be attached to the rear wall part 42. Parts relating to charging/discharging the battery 30 may also be stored in the rear wall part 42. For example, the rear wall part 42 may contain a circuit for charging the battery 30 and a heat sink 47 for cooling the components mounted on the circuit.

### Structure for supporting battery holder

As shown in FIG. 2, the battery holder 40 is supported by a stay 71. The stay 71 is attached to the right side surface of the battery holder 40, for example. More specifically, the stay 71 is attached to the right side surface 44c of the bottom part 44.

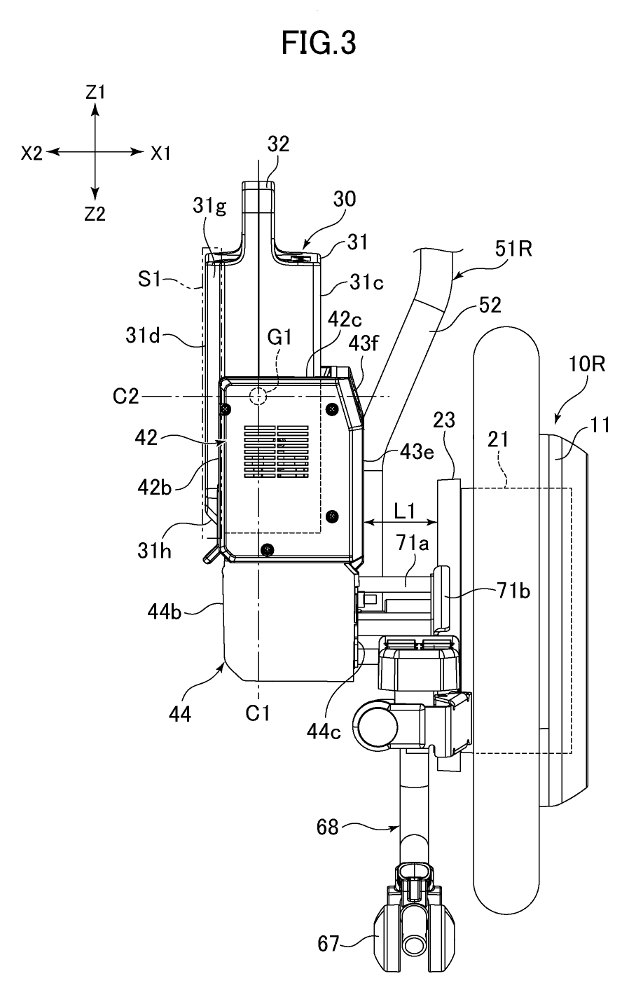

The stay 71 includes a mounting plate 71c (see FIG. 2) attached to the right side surface of the bottom part 44 using fasteners such as screws and bolts. The stay 71 includes a plurality of extensions 71a (see FIG. 5) extending rightward from the mounting plate 71c. The stay 71 includes a mounting plate 71b (see FIG. 5) fixed to the right ends of the extensions 71a. The mounting plate 71b is attached to the wheel 10L using fasteners such as screws and bolts. The mounting plate 71b is fixed to the motor housing 23, for example. Such a structure of the battery holder 40 provides a large distance L1 (see FIG. 3) between the right wheel 10R and the battery holder 40. As shown in FIG. 4, for example, the battery holder 40 may be positioned inward from the rear frame portion 52 of the right frame portion 51R (direction toward the center in the left-right direction).

### Shape of battery holder

As shown in FIG. 4, the battery holder 40 opens toward the top of the electric wheelchair 100 (Z1 direction in FIG. 1). The battery holder 40 opens inward (X2 direction in FIG. 1), which is the direction facing the center of the electric wheelchair 100 in the left-right direction. That is, the battery holder 40 opens toward the opposite side (left side) from the side where the stay 71 is attached. The battery holder 40 does not have a left wall part connecting the left edge of the front wall part 41 to the left edge of the rear wall part 42. As such, the left side surface 31d of the battery 30 is exposed inward (X2 direction in FIG. 1) with the battery 30 being mounted on the battery holder 40.

The structure of the battery holder 40 enables a reduction in the width of the vehicle body (distance between the wheels 10L and 10R) in the left-right direction when the frame 50 is folded without reducing the capacity of the battery 30. For example, the width of the vehicle body when the frame 50 is folded can be reduced compared to the case of using a conventional battery holder having four walls surrounding the right, left, front, and rear surfaces of the lower part of the battery.

In contrast to the example shown in FIG. 1, for example, the battery holder 40 may be disposed leftward of the center of the electric wheelchair 100 in the left-right direction. That is, the battery holder 40 may be disposed along the left wheel 10L. In this case, the battery holder 40 may be formed to open upward and rightward.

The battery 30 includes the left side surface 31d (see FIG. 6A) facing inward (left direction in the electric wheelchair 100). When the battery 30 is mounted on the battery holder 40, it is desirable that the entire left side surface 31d is exposed inward from the battery holder 40. More specifically, the battery holder 40 is preferably configured such that the range from a lower edge 31e (see FIG. 6A) to an upper edge 31f (see FIG. 6A) of the left side surface 31d is exposed inwardly.

### Relationship between battery and battery holder

As shown in FIG. 5, a width W1 of the inner surface 42a of the rear wall part 42 and the inner surface 41a of the front wall part 41 of the battery holder 40 in the left-right direction is smaller than a width W2 of the battery body 31 in the left-right direction. As such, as shown in FIG. 3, when the battery 30 is mounted on the battery holder 40, the battery body 31 includes, on its left side, a part 31g that is positioned leftward from the left side surface 42b of the rear wall part 42, the left side surface 41b of the front wall part 41, and the left side surface 44b of the bottom part 44 of the battery holder 40. Such a structure sufficiently provides a capacity of the battery 30 and further reduces the width of the vehicle body in the left-right direction (distance between the wheels 10L and 10R) when the battery 30 is removed and the frame 50 is folded as shown in FIG. 7.

The width of the part 31g in the left-right direction may be less than half of the width of the entire battery body 31 in the left-right direction. The width of the part 31g in the left-right direction may be less than one third of the width of the entire battery body 31 in the left-right direction. The width of the part 31g in the left-right direction may be larger than one eighth of the width of the entire battery body 31 in the left-right direction. The width of the part 31g in the left-right direction may be larger than one sixth of the width of the entire battery body 31 in the left-right direction.

As shown in FIG. 3, the bottom of the left side surface 31d of the battery body 31 may include a slope 31h extending downward to the battery holder 40. As such, the bottom of the battery body 31 may not have the part 31g. In other words, the part 31g is not necessarily formed over the entire surface of the battery body 31 from the top to the bottom, but may be formed only in a part of the range from the top to the bottom of the battery body 31. Unlike the example shown in FIG. 3, the part 31g may be formed throughout the range from the top to the bottom of the battery body 31. That is, the part 31g may not include the slope of 31h.

As shown in FIG. 3, when the battery 30 and the battery holder 40 are viewed in the front-rear direction, the center C1 of the battery 30 in the left-right direction (the center of the battery body 31) overlaps with the front wall part 41 and the rear wall part 42 of the battery holder 40 (in FIG. 3, C1 shows the plane passing through the center in the left-right direction). In other words, the center C1 of the battery 30 is positioned rightward from the left side surface 41b of the front wall part 41 and the left side surface 42b of the rear wall part 42. This serves to improve the support stability of the battery 30 by the battery holder 40.

As shown in FIG. 5, in a plan view of the battery 30 and the battery holder 40, the center C1 of the battery 30 in the left-right direction (the center of the battery body 31) may overlap with the bottom part 44 of the battery holder 40. In other words, the center C1 of the battery 30 is positioned rightward from the left side surface 44b of the bottom part 44. This serves to improve the support stability of the battery 30 by the battery holder 40.

As shown in FIG. 3, when the battery 30 and the battery holder 40 are viewed in the front-rear direction, the center of gravity G1 of the battery 30 overlaps with the front wall part 41 and the rear wall part 42 of the battery holder 40. In other words, the center of gravity G1 of the battery 30 is positioned rightward from the left side surface 41b of the front wall part 41 and the left side surface 42b of the rear wall part 42. This serves to improve the support stability of the battery 30 by the battery holder 40.

As shown in FIG. 5, in a plan view of the battery 30 and the battery holder 40, the center of gravity G1 of the battery 30 may overlap with the bottom part 44 of the battery holder 40. In other words, the center of gravity G1 of the battery 30 is positioned rightward from the left side surface 44b of the bottom part 44. This serves to improve the support stability of the battery 30 by the battery holder 40.

As shown in FIG. 3, the upper surfaces 41c, 42c, and 43c of the front wall part 41, the rear wall part 42, and the right wall part 43, respectively, are positioned higher than the center C2 of the battery body 31 in the vertical direction (C2 shows the horizontal surface passing through the center of the battery 30 in the vertical direction).

### Guide part

As shown in FIG. 4, the battery holder 40 includes guide parts 45. The guide parts 45 are formed on the inner surface of the front wall part 41 and the inner surface of the rear wall part 42, for example. The guide part 45 is a groove extending in the vertical direction, for example. The battery 30 includes guided parts 33 (see FIGS. 6A and 6B) formed on the front surface 31a and the rear surface 31b. The guided parts 33 are protrusions extending in the vertical direction, for example.

The guide parts 45 and the guided parts 33 fit together to restrict the movement of the battery 30 in the inward direction of the battery holder 40. That is, the battery 30 is prevented from separating from the battery holder 40 toward the center of the electric wheelchair 100 in the left-right direction. The guide parts 45 and the guided parts 33 allow the battery 30 to move in the vertical direction relative to the battery holder 40. That is, the battery 30 can be inserted into the battery holder 40 from the upper side.

As shown in FIG. 4, the slope at the top of the guide part 45 is formed such that the width of the top of the guide part 45 in the left-right direction is larger than the width W3 of the bottom of the guide part 45 in the left-right direction. This allows the battery30 to be easily inserted into the battery holder 40.

Unlike the examples shown in FIGS. 4 and 6A, grooves extending in the vertical direction may be formed on the front surface 31a and the rear surface 31b of the battery 30 as the guided parts 33. In this case, the guide part 45 may be a protrusion extending in the vertical direction.

As shown in FIG. 4, the upper surface 44a of the bottom part 44 of the battery holder 40 includes a slope 44i on its left edge. The slope 44i gradually descends to the left direction. The slope 44i continues from the front wall part 41 to the rear wall part 42. When the battery 30 is inserted into the battery holder 40, such a slope 44i prevents excessive force due to the collision between the battery 30 and the left edge of the bottom part 44 from acting on the battery 30 and the battery holder 40. Further, moisture (e.g., rainwater) falling inside the battery holder 40 can be discharged to the left side of the battery holder 44.

### Battery lock mechanism

The battery 30 and the battery holder 40 may be provided with a lock mechanism. For example, as shown in FIG. 6B, a protrusion 34a may be provided on the front surface 31a of the battery body 31, and a recess 46 (see FIG. 4) that catches the protrusion 34a may be formed on the front wall part 41 of the battery holder 40. The protrusion 34a may be coupled to an operation part 34b (see FIG. 6B) disposed on the handle 32. The operation part 34b and the protrusion 34a may be coupled to each other such that the protrusion 34a is recessed when the operation part 34b is pulled up.

As shown in FIG. 4, the inner surface 43a of the right wall part 43 of the battery holder 40 includes a slope 43d at its top. The slope 43d extends diagonally from its lower edge upward and outward in the left-right direction. The slope 43d is continuous from the front wall part 41 to the rear wall part 42. The slope 43d allows the battery 30 to be positioned at an appropriate place when the battery 30 is inserted into the battery holder 40 while the battery 30 is tilted to the right. The guide part 45 is easily fitted into the guided part 33.

### Space between battery holder and wheel

As described above, the battery holder 40 is supported by the stay 71 and separated from the wheel 10R in the inward (left) direction. Using the slope 43d described above, the battery 30 can be inserted into the battery holder 40 from a position close to the right wheel 10R. At this time, the space formed between the right wheel 10R and the battery holder 40 (distance L1 shown in FIG. 3) can function as a space for attaching and detaching the battery 30.

As described above, the electric wheelchair 100 includes the arm supports 64. The space between the right wheel 10R and the battery holder 40 may be used to move the arm support 64. As shown in FIG. 2, a support bar 64a is attached to the arm support 64. The support bar 64a is coupled to the seat frame portion 53 so as to be movable up and down with respect to the seat frame portion 53.

Alternatively, the electric wheelchair 100 may include a movable portion supporting the arm support 64. The movable portion may support the arm support 64 such that the arm support 64 moves between a horizontal position (position during use) where the arm support 64 is substantially horizontal as shown in FIG. 1, for example, and a vertical position where the arm support 64 is substantially vertical. If the electric wheelchair 100 includes such a movable portion, a part of the movable portion may be positioned in the space between the right wheel 10R and the battery holder 40 when the arm support 64 is in the vertical position.

As shown in FIG. 3, the right (outer) surface 43e of the right wall part 43 of the battery holder 40 may include a slope 43f at its top. With the slope 43f, the battery holder 40 may avoid interference with the movable portion supporting the arm support 64.

### Folding electric wheelchair

As shown in FIG. 2, the electric wheelchair 100 includes a stopper part 68b. The stopper part 68b is positioned closer to the left wheel 10L than the center of the wheelchair 100 in the left-right direction. The battery holder 40 includes a stopped part 44f (see FIG. 4) on its left side surface. As shown in FIG. 7, the stopper part 68b and the stopped part 44f come into contact with each other when the battery 30 is removed and the electric wheelchair 100 is folded. This prevents the distance between the left wheel 10L and the right wheel 10R from being smaller than the predetermined value D1. Such a structure serves to reduce the width of the vehicle body when the electric wheelchair 100 is folded compared to a structure in which the stopper part 44f is provided on a component other than the battery holder 40, for example.

As shown in FIG. 4, the stopped part 44f is formed on the left side surface 44b of the bottom part 44, for example. The bottom part 44 has a larger width (in the front-rear direction) than the side surfaces 41b and 42b of the other wall parts 41 and 42. As such, the stopped part 44f can be provided over a wide range. In this manner, the stopper part 68b can be reliably hit against the stopped part 44f when the electric wheelchair 100 is folded. The bottom part 44 includes a part at its front extends downward compared to the rear part. The left side surface of such a front part may function as the stopped part 44f.

As shown in FIG. 3, the left side surface 44b of the bottom part 44 where the stopped part 44f is formed and the left side surface 42b of the rear wall part 42 are positioned in substantially the same vertical plane. Similarly, the left side surface 44b of the bottom part 44 and the left side surface 41b of the front wall part 41 are positioned in substantially the same vertical plane. This structure can sufficiently provide the space formed inside the bottom part 44 (space for storing the cable and terminal base). Unlike the example shown in FIG. 3, the left side surface 44b of the bottom part 44 may be recessed to the right relative to the left side surfaces 41b and 42b of the wall parts 41 and 42. The stopped part 44f may be provided on the recessed left side surface 44b.

The stopped part 44f may be formed on other wall parts of the battery holder 40. For example, the stopped part 44f may be formed on the left side surface 41b of the front wall part 41 or the left side surface 42b of the rear wall part 42.

As shown in FIG. 2, the electric wheelchair 100 includes two rear casters 67. The two rear casters 67 are respectively positioned behind the left and right wheels 10L and 10R. The electric wheelchair 100 includes caster support mechanisms 68 that support the rear casters 67. The caster support mechanism 68 includes, at the front, a mounting part 68a to be attached to other parts of the vehicle body. The mounting part 68a is attached to the motor housing 23, for example. The caster support mechanism 68 extends backward from the mounting part 68a and supports the caster 67 at its end.

The stopper part 68b described above may be provided on the caster support mechanism 68, for example. The stopper part 68b may be provided on the mounting part 68a of the caster support mechanism 68, for example. The right surface of the mounting part 68a may function as the stopper part 68b, for example.

The position of the stopper part 68b is not limited to this. For example, the stopper part 68b may be provided on the left frame portion 51L or the left motor housing 23.

As shown in FIG. 3, the battery body 31 includes a part 31g positioned leftward of the left side surface 41b of the front wall part 41 and the left side surface 42b of the rear wall part 42 when mounted on the battery holder 40. That is, a space S1 to dispose the part 31g is provided on the left side of the battery holder 40. As shown in FIG. 7, when the battery 30 is removed from the battery holder 40 and the electric wheelchair 100 is folded, a part of the left frame portion 51L is positioned in front of the space S1. For example, the rear frame portion 52 of the left frame portion 51L may be positioned in front of the space S1.

Further, as shown in FIG. 7, when the battery 30 is removed from the battery holder 40 and the electric wheelchair 100 is folded, the lower part of the left frame portion 51L is positioned in front of the battery holder 40. As such, in the rear view of the electric wheelchair 100, the lower part of the left frame portion 51L (the lower part of the rear frame portion 52) overlaps with the battery holder 40.

Further, when the battery 30 is removed from the battery holder 40 and the electric wheelchair 100 is folded, a part of the left wheel 10L (e.g., motor housing 23) may be disposed in the space S1.

### Summary

(1) The power unit U includes an electric motor 21 mounted on the right wheel 10R, an electric motor 21 mounted on the left wheel 10L, a battery 30 that supplies a current to the electric motors 21, and a battery holder 40 that is disposed closer to the right wheel 10R than a center of the electric wheelchair 100 in a left-right direction and houses the battery 30. The battery holder 40 opens toward an inward direction, which is a direction facing the center of the electric wheelchair 100 in the left-right direction, and toward a top of the electric wheelchair 100.

The structure of the battery holder 40 enables to reduce the width of the vehicle body (distance between the wheels 10L and 10R) in the left-right direction when the frame 50 is folded without reducing the capacity of the battery 30. For example, the width of the vehicle body when the frame 50 is folded can be reduced compared to the case of using a conventional battery holder having four walls surrounding the right, left, front, and rear surfaces of the lower part of the battery.

(2) In the power unit U of (1), the battery 30 includes a left side surface 31d facing in the inward direction. When the battery 30 is mounted on the battery holder 40, the entire left side surface 31d is exposed from the battery holder 40 in the inward direction.

(3) In the power unit U of (1) or (2), the battery 30 includes a front surface 31a facing forward of the electric wheelchair 100 and a rear surface 31b facing rearward of the electric wheelchair 100. The battery holder 40 includes a front wall part 41 along the front surface 31a and a rear wall part 42 along the rear surface 31b. The front wall part 41 includes an inner surface 41a along the front surface 31a of the battery 30. The rear wall part 42 includes an inner surface 42a along the rear surface 31b of the battery 30. A width W1 of the inner surface 41a and the inner surface 42a in the left-right direction is smaller than a width W2 of the battery 30 in the left-right direction. The capacity of the battery 30 can be increased while reducing the width of the vehicle body when the frame 50 is folded.

(4) In the power unit U of (3), when the battery 30 and the battery holder 40 are viewed in a front-rear direction, a center of gravity G1 of the battery 30 overlaps with the front wall part 41 and the rear wall part 42. This serves to improve stability in supporting the battery 30.

(5) In the power unit U of (3) or (4), when the battery 30 and the battery holder 40 are viewed in the front-rear direction, a plane C1 passing through the center of the battery 30 in the left-right direction intersects the front wall part 41 and the rear wall part 42. This serves to improve stability in supporting the battery 30.

(6) In the power unit U of any one of (3) to (5), an upper surface 41c of the front wall part 41 and an upper surface 42c of the rear wall part 42 are positioned higher than the center C2 of the battery 30 in a vertical direction. This serves to improve stability in supporting the battery 30.

(7) In the power unit U of any one of (1) to (6), the battery 30 includes a left side surface 31d facing in the inward direction and a right side surface 31c facing in an outward direction, which is opposite to the inward direction. The battery holder 40 includes a right wall part 43 along the right side surface 31c of the battery 30. The right wall part 43 includes an inner surface 43a facing in the inward direction. A top of the inner surface 43a includes a slope 43d. The slope 43d extends diagonally from a lower edge of the slope 43d upward and in the right direction. The structure of the slope 43d allows the battery 30 to be positioned at an appropriate place when the battery 30 is inserted into the battery holder 40 while the battery 30 is tilted to the right.

(8) In the power unit U of any one of (1) to (7), the battery holder 40 includes a guide part 45. The battery 30 includes a guided part 33. The guide part 45 and the guided part 33 allow a movement of the battery 30 in a vertical direction with respect to the battery holder 40 and restricts a movement of the battery 30 in the inward direction from the battery holder 40.

(9) The electric wheelchair 100 proposed in the present disclosure includes the power unit U and the left and right wheels 10L and 10R of any one of (1) to (8).

(10) The electric wheelchair 100 of (9) includes a stopper part 68b that is positioned closer to the left wheel 10L than the center of the electric wheelchair 100 in the left-right direction. The battery holder 40 includes a stopped part 44f. When the electric wheelchair 100 is folded, the stopper part 68b and the stopped part 44f come into contact with each other so as to prevent a distance L1 between the right wheel 10R and the left wheel 10L from being smaller than a predetermined value. Such a structure serves to reduce the width of the vehicle body when the electric wheelchair 100 is folded compared to a structure in which the stopper part 44f is provided on a component other than the battery holder 40, for example.

(11) In the electric wheelchair 100 of (10), the battery holder 40 includes a side surface 44b facing in the inward direction. The stopped part 44f is provided on the side surface 44b.

(12) In the electric wheelchair 100 of (10) or (11), the battery holder 40 includes a bottom part 44 that supports a lower surface of the battery 30. The stopped part 44f is provided on the bottom part 44. With this structure, the stopped part 44f can be provided over a wide range. In this manner, the stopper part 68b can be reliably hit against the stopped part 44f when the electric wheelchair 100 is folded.

(13) In the electric wheelchair of any one of (10) to (12), the battery 30 includes a front surface 31a facing forward of the electric wheelchair 100 and a rear surface 31b facing rearward of the electric wheelchair 100. The battery holder 40 includes a front wall part 41 along the front surface 31a and a rear wall part 42 along the rear surface 31b. The battery 30 includes a part 31g that is positioned further in the inward direction from a left side surface 41b of the front wall part 41 and a left side surface 42b of the rear wall part 42 when the battery 30 is mounted on the battery holder 40, where the left side surfaces 41b and 42b are facing in the inward direction. A space S1 to dispose the part 31g of the battery 30 is provided in the inward direction of the battery holder 40. A left frame portion 51L closer to the left wheel 10L is positioned in front of the space S1 when the electric wheelchair 100 is folded in a state where the battery 30 is removed from the battery holder 40.

(14) In the electric wheelchair 100 of any one of (9) to (13), the battery 30 includes a left side surface 31d facing in the inward direction and a right side surface 31c facing in an outward direction, which is opposite to the inward direction. The battery holder 40 includes a right wall part 43 along the right side surface 31c of the battery 30. The right wall part 43 includes an inner surface 43a facing toward a center of the electric wheelchair 100 in a left-right direction. A top of the inner surface 43a includes a slope 43d extending diagonally from a lower edge of the slope 43d upward and in the outward direction. The battery holder 40 is supported away from the right wheel 10R in the inward direction (left direction). With this structure, using the slope 43d, the battery 30 can be inserted into the battery holder 40 from a position close to the right wheel 10R. At this time, the space formed between the right wheel 10R and the battery holder 40 can function as a space for attaching and detaching the battery 30.

### Others

The power unit and the electric wheelchair proposed in the present disclosure are not limited to the power unit U and the electric wheelchair 100 described above, and various changes may be made.

For example, in the electric wheelchair 100, the battery body 31 includes the part 31g positioned leftward of the left side surfaces 41b, 42b, and 44b of the battery holder 40. However, the battery 30 may not include such a part 31g.

Although the present invention has been illustrated and described herein with reference to embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A power unit of an electric wheelchair that includes a first wheel, which is one of a right wheel or a left wheel, and a second wheel, which is the other one of the right wheel or the left wheel, and is foldable so as to reduce a distance between the first wheel and the second wheel, the power unit being mounted on the electric wheelchair and comprising:
a first electric motor mounted on the first wheel;
a second electric motor mounted on the second wheel;
a battery that supplies a current to the first electric motor and the second electric motor; and
a battery holder that is disposed closer to the first wheel than a center of the electric wheelchair in a left-right direction and houses the battery, wherein
the battery holder opens toward an inward direction, which is a direction facing the center of the electric wheelchair in the left-right direction, and toward a top of the electric wheelchair.

2. The power unit of the electric wheelchair according to claim 1, wherein
the battery comprises a first side surface facing in the inward direction, and
when the battery is mounted on the battery holder, the entire first side surface is exposed from the battery holder in the inward direction.

3. The power unit of the electric wheelchair according to claim 1, wherein
the battery comprises a front surface facing forward of the electric wheelchair and a rear surface facing rearward of the electric wheelchair,
the battery holder comprises a front wall part along the front surface and a rear wall part along the rear surface,
the front wall part comprises a first inner surface along the front surface of the battery,
the rear wall part comprises a second inner surface along the rear surface of the battery, and
a width of the first inner surface and the second inner surface in the left-right direction is smaller than a width of the battery in the left-right direction.

4. The power unit of the electric wheelchair according to claim 3, wherein
when the battery and the battery holder are viewed in a front-rear direction, a center of gravity of the battery overlaps with the front wall part and the rear wall part.

5. The power unit of the electric wheelchair according to claim 3, wherein
when the battery and the battery holder are viewed in the front-rear direction, a plane passing through the center of the battery in the left-right direction intersects the front wall part and the rear wall part.

6. The power unit of the electric wheelchair according to claim 3, wherein
an upper surface of the front wall part and an upper surface of the rear wall part are positioned higher than the center of the battery in a vertical direction.

7. The power unit of the electric wheelchair according to claim 1, wherein
the battery comprises a first side surface facing in the inward direction and a second side surface facing in an outward direction, which is opposite to the inward direction,
the battery holder comprises a side wall part along the second side surface of the battery,
the side wall part comprises an inner surface facing in the inward direction,
a top of the inner surface comprises a slope, and
the slope extends diagonally from a lower edge of the slope upward and in the outward direction.

8. The power unit of the electric wheelchair according to claim 1, wherein
the battery holder comprises a guide part,
the battery comprises a guided part, and
the guide part and the guided part allow a movement of the battery in a vertical direction with respect to the battery holder and restricts a movement of the battery in the inward direction from the battery holder.

9. An electric wheelchair comprising
a power unit of an electric wheelchair that comprises a first wheel, which is one of a right wheel or a left wheel, and a second wheel, which is the other one of the right wheel or the left wheel, and is foldable so as to reduce a distance between the first wheel and the second wheel, the power unit being mounted on the electric wheelchair and comprising:
a first electric motor mounted on the first wheel;
a second electric motor mounted on the second wheel;
a battery that supplies a current to the first electric motor and the second electric motor; and
a battery holder that is disposed closer to the first wheel than a center of the electric wheelchair in a left-right direction and houses the battery, wherein
the battery holder opens toward an inward direction, which is a direction facing the center of the electric wheelchair in the left-right direction, and toward a top of the electric wheelchair.

10. The electric wheelchair according to claim 9, comprising a stopper part that is positioned closer to the second wheel than the center of the electric wheelchair in the left-right direction, wherein
the battery holder comprises a stopped part, and
when the electric wheelchair is folded, the stopper part and the stopped part come into contact with each other so as to prevent a distance between the first wheel and the second wheel from being smaller than a predetermined value.

11. The electric wheelchair according to claim 10, wherein
the battery holder comprises a side surface facing in the inward direction, and
the stopped part is provided on the side surface.

12. The electric wheelchair according to claim 10, wherein
the battery holder comprises a bottom part that supports a lower surface of the battery, and
the stopped part is provided on the bottom part.

13. The electric wheelchair according to claim 10, wherein
the battery comprises a front surface facing forward of the electric wheelchair and a rear surface facing rearward of the electric wheelchair,
the battery holder comprises a front wall part along the front surface and a rear wall part along the rear surface,
the battery comprises a part that is positioned further in the inward direction from a side surface of the front wall part and a side surface of the rear wall part when the battery is mounted on the battery holder, the side surfaces facing in the inward direction,
a space to dispose the part of the battery is provided in the inward direction of the battery holder, and
in a state where the battery is removed from the battery holder and the electric wheelchair is folded, a frame of the electric wheelchair which is closer to the second wheel is positioned in front of the space.

14. The electric wheelchair according to claim 9, wherein
the battery comprises a first side surface facing in the inward direction and a second side surface facing in an outward direction, which is opposite to the inward direction,
the battery holder comprises a side wall part along the second side surface of the battery,
the side wall part comprises an inner surface facing toward a center of the electric wheelchair in a left-right direction,
a top of the inner surface comprises a slope extending diagonally from a lower edge of the slope upward and in the outward direction, and
the battery holder is supported away from the first wheel in the inward direction.
